(19) United States
(12) Patent Application Publication
(10) Pub. No.: US 2024/0289766 A1
(43) Pub. Date: Aug. 29, 2024

(54) SYSTEM AND METHOD FOR THE AUTOMATED PROVISION OF TRANSACTIONAL DATA

(71) Applicant: Chargezoom Inc., Irvine, CA (US)

(72) Inventor: Matthew Dubois, Irvine, CA (US)

(21) Appl. No.: 18/652,404

(22) Filed: May 1, 2024

Related U.S. Application Data
(63) Continuation-in-part of application No. 17/587,494, filed on Jan. 28, 2022.
(60) Provisional application No. 63/285,063, filed on Dec. 1, 2021.

(51) Int. Cl. G06Q 20/24; G06Q 40/03

(52) U.S. Cl. CPC G06Q 20/24; G06Q 40/03

(57) ABSTRACT

In various embodiments, a computer-implemented method for the automatic provision of transactional data can include: by a computer system, accessing a credit transaction including an initial transaction profile and an initial risk profile; by the computer system, accessing an external server including an external data set associated with the credit transaction; by the computer system, augmenting the initial transaction profile with the external data set to generate a secondary transaction profile and a secondary risk profile; by the computer system, transmitting the secondary transaction profile to a credit server associated with a credit provider; and by the computer system, receiving a confirmation from the credit server of the secondary transaction profile associated with the credit transaction. In additional embodiments, the external data set can include publicly available data and the secondary transaction profile can include level three transaction data.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

The present application is a continuation-in-part (CIP) of, and claims the benefit of and priority to, U.S. Non-Provisional application Ser. No. 17/587,494, filed on Jan. 28, 2022, which claims priority to U.S. Provisional Patent Application No. 63/285,063, filed on Dec. 1, 2021. The subject matter thereof is hereby incorporated by reference in its entirety.

### STATEMENT REGARDING FEDERALLY SPONSORED RESEARCH OR DEVELOPMENT

Not Applicable.

### REFERENCE TO SEQUENCE LISTING OR COMPUTER PROGRAM LISTING APPENDIX

Not Applicable.

### BACKGROUND

The present invention relates to the field of cashless payment technologies and, more particularly, to a system and method for the automated provision of transactional data in cashless payment systems.

An increasing number of businesses and consumers are utilizing credit based and/or financed payments for goods and services. In credit card transactions, a set of entities control a network through which banks (both acquiring and issuing) conduct credit-based transactions. As compensation for use of the network, the set of entities (e.g., cashless payment entities) charge an interchange rate that is typically determined as a function of the risk associated with the transaction. Generally, transactions that are characterized by more data are considered lower risk, and therefore the usage fees associated with the network are lower.

Generally, the risk of loss due to fraud or chargeback is borne by the acquiring bank, which selects the merchants and assesses the risk accordingly. For example, an acquiring bank can examine a merchant's credit score and determine a rate to charge the merchant (typically the interchange rate plus a risk premium). Thus, only a portion of the fees charged to the merchant are for use of the network (e.g., the interchange rate), with the remainder including profit and/or risk offset to the acquiring bank.

The interchange rate can vary depending upon the level of data supplied to the cashless payment entity in order to minimize potential risks to its users, including merchants, issuing banks, and acquiring banks. However, typical data gathering systems leveraged by the cashless payment entities are engineered for ease and simplicity and to ensure capture of the sale, therefore all but eliminating the ability for users to acquire the necessary data to lower the interchange rate. For example, a typical credit card transaction may ask for a purchaser name, merchant name, purchase amount, and billing zip code, which is a relatively low level of data and therefore results in a higher interchange rate on the network of the cashless payment entity. Moreover, existing data capture systems cannot automatically gather, normalize, format, store and transmit the necessary data to the cashless payment entities associated with the network. Rather, existing data capture systems rely entirely upon distributed, asynchronous, and tedious data gathering, data cleaning, and data entry, the costs of which do not offset any gains to be received through a lower interchange rate.

Accordingly, there is a need in the art for improved technologies and methods to enable automated gathering, normalizing, formatting, storage, and transmission of transaction related data.

### BRIEF SUMMARY

Certain embodiments of the present invention can provide solutions to the technical problems and needs in the art that have not yet been fully identified, appreciated, or solved by current credit-based payment network technologies.

In one embodiment, a computer-implemented method for the automatic provision of transactional data can include: by a computer system, accessing a credit transaction including an initial transaction profile and an initial risk profile; by the computer system, accessing an external server including an external data set associated with the credit transaction; by the computer system, augmenting the initial transaction profile with the external data set to generate a secondary transaction profile and a secondary risk profile; by the computer system, transmitting the secondary transaction profile to a credit server associated with a credit provider; and by the computer system, receiving a confirmation from the credit server of the secondary transaction profile associated with the credit transaction.

In another embodiment, the method can include by the computer system, accessing a second external server including a second external data set associated with the credit transaction, wherein the second external server includes a database including publicly available data.

In another embodiment of the method, the initial transaction profile includes an initial purchaser dataset and an initial merchant dataset; and the initial risk profile is computed in response to the initial transaction profile.

In another embodiment, the method can include by the computer system, importing an element from the external data set; by the computer system, formatting the element into a compatible format; by the computer system, automatically entering the formatted element into one of the initial purchaser dataset or the initial merchant dataset.

In another embodiment of the method, the formatted element includes level three transactional data.

In yet another embodiment of the method, the secondary risk profile is computed in response to the secondary transaction profile.

In still another embodiment of the method, receiving a confirmation from the credit server of the secondary transaction profile associated with the credit transaction includes: receiving, from the credit server, a discounted interchange rate associated with the credit transaction.

Another embodiment can include a computer system for the automatic provision of transactional data including: at least one processor; and memory including a set of instructions for the automatic provision of transactional data, wherein the set of instructions, with the at least one processor, is configured to cause the computer system to: access a credit transaction including an initial transaction profile and an initial risk profile; access an external server including an external data set associated with the credit transaction; augment the initial transaction profile with the external data set to generate a secondary transaction profile and a secondary risk profile; transmit the secondary transaction profile to a credit server associated with a credit provider; and receive a confirmation from the credit server of the secondary transaction profile associated with the credit transaction.

In another embodiment, the set of instructions, together with the at least one processor, are further configured to: access a second external server including a second external data set associated with the credit transaction, wherein the second external server includes a database including publicly available data.

In another embodiment of the computer system, the initial transaction profile includes an initial purchaser dataset and an initial merchant dataset; and the initial risk profile is computed in response to the initial transaction profile.

In another embodiment the set of instructions and at least one processor are further configured to: import an element from the external data set; format the element into a compatible format; and automatically enter the formatted element into one of the initial purchaser dataset or the initial merchant dataset.

In another embodiment of the computer system, the formatted element comprises level three transactional data.

In yet another embodiment of the computer system, the secondary transaction profile is computed in response to the secondary transaction profile.

In still another embodiment of the computer system, the set of instructions and at least one processor are configured to: receive, from the credit server, a discounted interchange rate associated with the credit transaction.

Another embodiment includes a computer program embodied on a non-transitory computer readable medium, wherein the computer program when executed is configured to cause at least one processor to: access a credit transaction including an initial transaction profile and an initial risk profile; access an external server including an external data set associated with the credit transaction; augment the initial transaction profile with the external data set to generate a secondary transaction profile and a secondary risk profile; transmit the secondary transaction profile to a credit server associated with a credit provider; and receive a confirmation from the credit server of the secondary transaction profile associated with the credit transaction.

In another embodiment, the computer program product is further configured to cause at least one processor to: access a second external server including a second external data set associated with the credit transaction, wherein the second external server includes a database including publicly available data.

In another embodiment of the computer program product, the initial transaction profile includes an initial purchaser dataset and an initial merchant dataset; and the initial risk profile is computed in response to the initial transaction profile.

In another embodiment, the computer program product is further configured to cause the at least one processor to: import an element from the external data set; format the element into a compatible format; automatically enter the formatted element into one of the initial purchaser dataset or the initial merchant dataset.

In another embodiment of the computer program product, the formatted element includes level three transactional data; and the secondary risk profile is computed in response to the secondary transaction profile.

In another embodiment, the computer program product is further configured to cause at least one processor to receive, from the credit server, a discounted interchange rate associated with the credit transaction.

These and other embodiments, and variations and alternatives thereof, are described below in detail with reference to the following figures.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a schematic diagram of an operating environment of a computer system in accordance with one embodiment of the present invention;

FIG. 2 is a schematic block diagram of an exemplary computer system in accordance with another embodiment of the present invention;

FIG. 3 is a schematic block diagram of an operating environment of a computer system in accordance with another embodiment of the present invention;

FIG. 4 is a flow chart of a method in accordance with another embodiment of the present invention.

FIG. 5 is a block diagram of a data enrichment process according to example embodiments of the present invention.

FIG. 6 is a flow diagram of an example process for data enrichment according to example embodiments of the present invention.

FIG. 7 is a schematic diagram illustrating the exchange of financial data in accordance with the exemplary method of FIG. 6, according to an embodiment of the present invention.

FIG. 8 is an illustration of adjusted financial data in accordance with the exemplary method of FIG. 6, according to an embodiment of the present invention.

### DETAILED DESCRIPTION

### 1. Overview

Generally, various embodiments of the computer system 100 are configured to: automatically retrieve, access, and acquire level three transaction data from a variety of databases; automatically format and translate disparate data streams into a uniform transaction data reporting format; and automatically submit full sets of level three transaction data to servers or systems associated with credit-granting entities to minimize the amount of assessed risk associated with a credit-based transaction.

In some embodiments, the computer system 100 is in communication with a payment processing entity (e.g., a payment gateway) and one or more servers (e.g., credit servers) associated with a credit provider (e.g., a cashless payment entity). The computer system 100 can therefore function as an intermediary service that interfaces between the credit server and the payment gateway. In other embodiments, the computer system 100 can be integrated into the payment gateway. In other embodiments, the computer system 100 can be integrated into the credit server. In still other embodiments, the computer system 100 can be configured as a cloud-based technological solution that is accessible to and/or interfaces with multiple payment gateways and multiple credit servers to provide seamless and complete transaction data to the credit-granting entities and thus relieve some financing burden on the payment processing entities.

### 2. Benefits

As described in detail below, the computer system 100 can be configured to retrieve, standardize, normalize, populate, and/or reconcile transactional data sets relating to credit-based transactions to generate full-scope level three transactional data and lessen the perceived risk in financed transactions. In doing so, the computer system 100 can relieve payment processing entities and/or merchants from having to inefficiently retrieve and/or enter certain transaction data using existing technologies. Moreover, the computer system 100 can lessen the processing time for level three transactions by automatically accessing the appropriate transaction data, formatting the transaction data, and transmitting the transaction data to one or more of the payment gateway or the credit server.

One benefit of the various embodiments of the computer system 100 is that the computer system 100 provides seamless and automated acquisition, presentation, and transmission of level three transaction data to both payment processing entities and credit-granting entities. In operation, the computer system 100 can be configured to access, present, and transmit uniform level three transaction data to interested entities. In other embodiments, the computer system 100 can be configured to access, present, and transmit custom level three transaction data to distinct entities, depending upon the type of transaction data requested and/or required by such entities. Generally, level three transaction data can include some or all of the following data: merchant name, transaction amount, date, merchant zip code, merchant tax identification number, discount amount, shipping amount, duty amount, item commodity code, item descriptor, product code, quantity, unit of measure, unit of cost, discount per line item, ship-to zip code, ship-from zip code, destination country, VAT information, tax amount, tax indicator, customer code, debit or credit indicator, SKU, split shipments, corporate status, small business status, supplier reference code, and/or supplier reference number. In accessing these data, the computer system 100 can interface with and/or access one or more databases relating to the merchant and/or the purchaser, as well as publicly available databases that include publicly available information relating to the transaction (e.g., a tax type/amount for a ship-to or ship-from zip code).

Advantageously, various embodiments of the computer system 100 can access, ingest, translate, and format these disparate data sets into uniformly presented data fields for the transmission and acceptance of level three transaction data. For example, zip (postal) code data can be provided in numerous formats within the United States (five-digit code, five-digit code plus four, etc.), and even more formats outside the United States. As described in detail below, embodiments of the computer system 100 can automatically translate and format ship-from zip code data and ship-to zip code data into standardized formats for receipt and acknowledgement of the level three transaction data.

Additional benefits of the various embodiments of the computer system 100 include greatly increased transparency between electronic transaction platforms, real-time or near real-time acquisition and exchange of level three transaction data across electronic transaction platforms, and increased efficiency and integration with existing financial software and customer relations management technologies.

### 3. Computer System Architecture

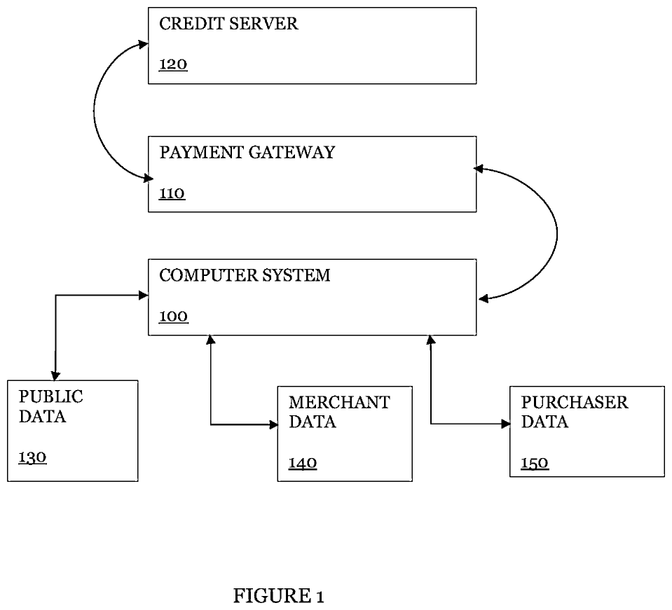

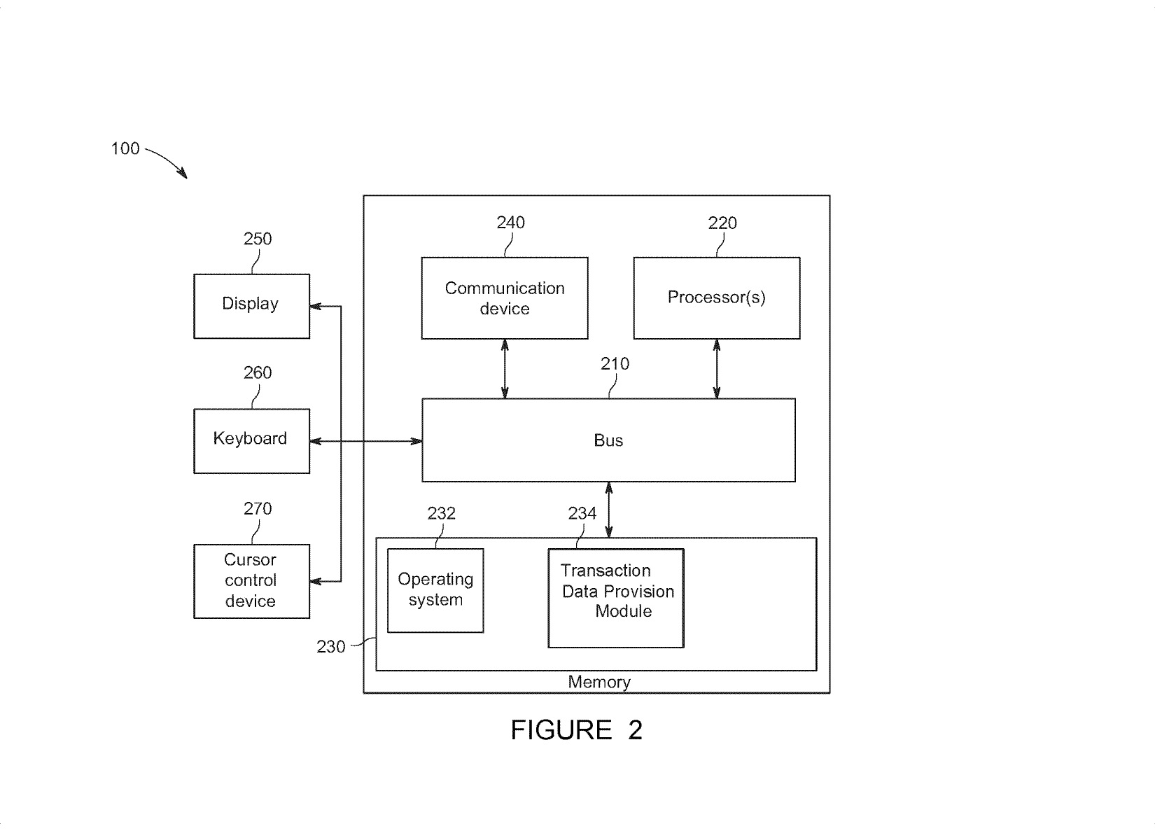

Generally, the methods and techniques described herein are performed by a computer system 100, as shown in FIGS. 1 and 2. For example, FIG. 2 is an exemplary architectural diagram illustrating a computer system 100 configured to automatically reconcile and synchronize distinct data sets in an end-to-end manner between a credit provider associated with a credit server 120 and a payment gateway 110 associated with a merchant or vendor. In some embodiments, the computer system 100 is configured as a cloud based platform or service that can access other software applications, services, servers, datasets, and/or databases associated with the user-merchant, purchaser-payor, credit card network, one or more payment gateways, one or more payment providers, and one or more public/private data sets, etcetera.

In some embodiments, the computer system 100 can be one or more of the computing systems depicted and/or described herein. The computer system 100 can include a bus 210 or other communication mechanism for communicating information, and one or more processor(s) 220 coupled to the bus 210 for processing information. The processor(s) 220 can be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. The processor(s) 220 can also have multiple processing cores, and at least some of the cores can be configured to perform specific functions. Multi-parallel processing can be used in some embodiments. In certain embodiments, at least one of the processor(s) 220 can be a neuromorphic circuit that includes processing elements that mimic biological neurons. In some embodiments, neuromorphic circuits might not require the typical components of a Von Neumann computing architecture.

The computer system 100 can also include a memory 230 for storing information and instructions to be executed by the processor(s) 220. The memory 230 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media can be any available media that can be accessed by the processor(s) 220 and can include volatile media, non-volatile media, or both. The media can also be removable, non-removable, or both.

Additionally, the computer system 100 can include a communication device 240, such as a transceiver, to provide access to a communications network via a wireless and/or wired connection. In some embodiments, the communication device 240 can be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the claimed invention. In some embodiments, the communication device 240 can include one or more antennas that are singular, arrayed, phased, switched, beamforming, beamsteering, a combination thereof, and or any other antenna configuration without deviating from the scope of the claimed invention.

The processor(s) 220 are further coupled via the bus 210 to a display 250, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. The display 250 can be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etcetera. Any suitable display device and haptic I/O can be used without deviating from the scope of the claimed invention.

A keyboard 260 and a cursor control device 270, such as a computer mouse, a touchpad, etc., are further coupled to the bus 210 to enable a user to interface with the computer system 100. However, in certain embodiments, a physical keyboard and mouse might not be present, and the user can interact with the computer system 100 solely through display 250 and/or a touchpad (not shown). Any type and combination of input devices can be used as a matter of design choice. In certain embodiments, no physical input device and/or display is present. For instance, the computer system 100 can be configured as a cloud-based or remote server-based system, in which case the user can interact with computer system 100 remotely via another system (not shown) in communication therewith. In still other embodiments, the computer system 100 can operate autonomously, semi-autonomously, or by implementing machine learning techniques.

The memory 230 stores software modules that provide functionality when executed by the processor(s) 220. The modules can include an operating system 232 for computer system 100. The modules can further include a transaction data provision module 234 that is configured to perform all or part of the processes, techniques, or methods described herein or derivatives thereof. The computer system 100 can include one or more additional modules that include additional functionality.

One skilled in the art will appreciate that a “computer system” could be embodied as a server, an embedded computing system, a personal computer, a console, a personal digital assistant (PDA), a cell phone, a tablet computing device, a quantum computing system, or any other suitable computing device, or combination of devices without deviating from the scope of the claimed invention. Presenting the above-described functions as being performed by a “computer system” is not intended to limit the scope of the claimed invention in any way, but is intended to provide one example of the many embodiments of the claimed invention. Indeed, methods, systems, and apparatuses disclosed herein can be implemented in localized and distributed forms consistent with computing technology, including cloud computing systems.

It should be noted that some of the computer system 100 features described in this specification have been presented as modules, in order to emphasize their implementation independence more particularly. For example, a module can be implemented as a hardware circuit comprising custom very large scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices, graphics processing units, or the like.

A module can also be at least partially implemented in software for execution by various types of processors. An identified unit of executable code can, for instance, include one or more physical or logical blocks of computer instructions that can, for instance, be organized as an object, procedure, or function. Nevertheless, the executables of an identified module need not be physically located together, but can include disparate instructions stored in different locations that, when joined logically together, comprise the module and achieve the stated purpose for the module. Further, modules can be stored on a computer-readable medium, which can be, for instance, a hard disk drive, flash device, RAM, tape, and/or any other such non-transitory computer-readable medium used to store data without deviating from the scope of the invention.

Indeed, a module of executable code could be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network.

The process steps performed in by the system 100 can be performed by a computer program, encoding instructions for the processor(s) to perform at least part of the process(es), techniques, or methods described herein, in accordance with embodiments of the claimed invention. The computer program can be embodied on a non-transitory computer-readable medium. The computer-readable medium can be, but is not limited to, a hard disk drive, a flash device, RAM, a tape, and/or any other such medium or combination of media used to store data. The computer program can include encoded instructions for controlling the processor(s) of a computer system (e.g., the processor(s) 220 of the computer system 100 of FIG. 2) to implement all or part of the process steps described in herein, which can also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

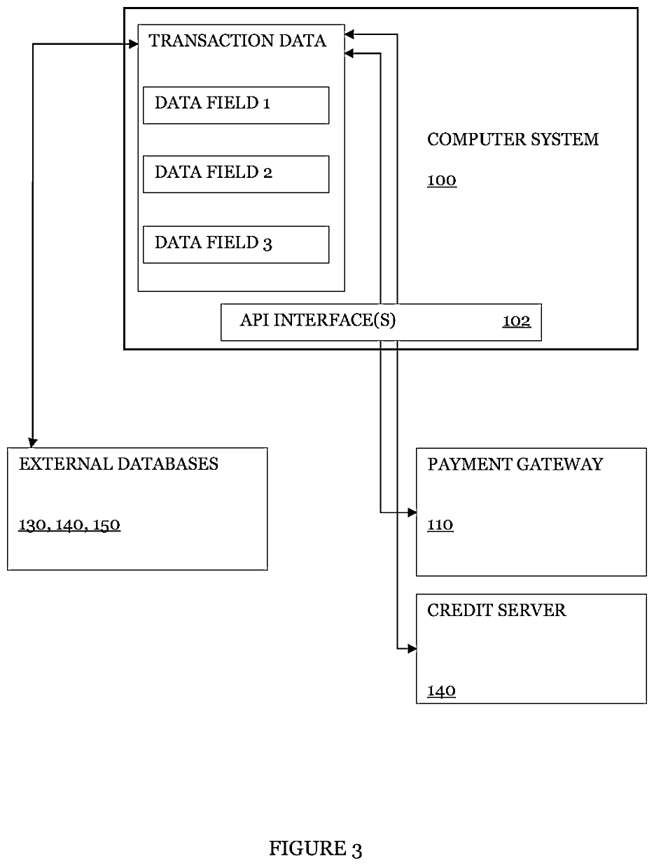

As shown in FIGS. 1 and 3, in one embodiment the computer system 100 can be connected, for example through one or more application programming interfaces (APIs) 102, to a payment gateway 110, a credit server 120 (e.g., a credit server associated with a credit provider) associated with a credit transaction (e.g., a credit card transaction), and one or more external databases including for example a public database 130, a merchant database 140, and a purchaser database 150. As described in detail below, in some embodiments two or more of the external databases 130, 140, 150 can be assembled, combined, and/or managed as a single database and integrated with the computer system 100. In some embodiments, the merchant database 140 and/or the purchaser database 150 can be associated with and/or resident within a merchant accounting system, enterprise resource planning (ERP) platform, and/or a customer relations management (CRM) platform. In some embodiments, the merchant database 140 and/or purchaser database 150 can be integral with or associated with cloud-based software-as-a-service (SaaS) computing platforms. In other embodiments, one or more of the computer system 100, the payment gateway 110, and/or the credit server 120 can be implemented in a remote server and/or cloud-based software platform.

In variations of the embodiments, the computer system 100 can be connected and/or connectable to one or more of the external databases 130, 140, 150 the payment gateway 110, and/or the credit server 120 via one or more application programming interfaces (APIs) that permit the computer system 100 to: submit a request for data from the associated platform; receive or pull data from the associated platform; respond to a request for data from the associated platform; and transmit or push data to the associated platform. In some embodiments, the computer system 100 and associated platforms can execute REST APIs. In other embodiments, the computer system 100 can associated platforms can execute SOAP APIs. In still other embodiments, the computer system 100 and associated platforms can execute APIs of other types or formats.

As shown in FIGS. 1 and 3, embodiments of the computer system 100 can access a credit transaction from the payment gateway 110 and/or the credit server 120. Generally, the credit transaction can include or be characterized by a set of underlying data from which an initial transaction profile and an initial risk profile is derived. In some embodiments, the initial transaction profile includes a set of data relating to the transaction, including information pertaining to the merchant, the purchaser, the credit provider associated with the credit server 120, and/or the good/service being sold. In some embodiments, the initial risk profile is then generated in response to or as a function of the initial transaction data, and a borrowing rate is assigned to the transaction based at least in part upon the initial risk profile.

In variations of the embodiments, the computer system 100 can access an external server 130, 140, 150 including an external data set associated with the credit transaction. For example, an external data set can include data and/or information relating to the merchant, the purchaser, the product, the location and/or jurisdiction of the purchase/sale, the means or method of delivery or shipment, etcetera. In some embodiments, the computer system 100 can access one or more external servers 130, 140, 150, at least one of which includes publicly available data (e.g., sales tax rates at the point of purchase/sale). In other embodiments, the computer system 100 can access the one or more external servers 130, 140, 150 to retrieve, pull, scrape, and/or copy data or information that supports level three transactional data for the credit transaction.

As shown in FIGS. 1 and 3, in some embodiments the computer system 100 can: augment the initial transaction profile with the external data set to generate a secondary transaction profile and a secondary risk profile. As noted above, the initial transaction profile and the initial risk profile can be used by a credit issuing entity to set a rate of borrowing that is proportional to a level of risk associated with the transaction. Accordingly, the computer system 100 can access the external data sets as described herein, augment or supplement the initial transaction profile with the externally-obtained information or data, and then generate a secondary transaction profile that includes a more complete (e.g., level three transaction data) assessment of the risk associated with the transaction.

In variations of the embodiments, the computer system 100 augments the initial transaction profile by completing a set of informational or data fields that provide a full set of level three transaction data. In other embodiments, the computer system can import a data element from the external data set (e.g., a middle initial of the purchaser, a purchaser zip code, a merchant zip code, shipping origin and destinations, etc.). Generally, the external data imported by the computer system 100 will not be in a standardized or normalized format, for example state abbreviations, zip code plus four formats, and the like. Accordingly, the computer system 100 can further format, transform, translate, and/or normalize the data element the element into a compatible format suitable for reporting level three transaction data. In another embodiment, the computer system can automatically enter the formatted element into one of the initial purchaser dataset or the initial merchant dataset. For example, if the computer system 100 retrieves additional data relating to the merchant from a merchant database 140, then the computer system 100 can automatically import, enter, or complete remaining data fields within the initial merchant dataset such that all (or substantially all) of the required data fields contain accurate and properly formatted information. Similarly, if the computer system 100 retrieves additional data relating to the purchaser from a public database 130 (e.g., sales tax jurisdiction and rate), then the computer system 100 can automatically import, enter, or complete remaining data fields within the initial vendor dataset such that all (or substantially all) of the required data fields contain accurate and properly formatted information.

In other variations of the embodiments, the computer system 100 can transmit the secondary transaction profile to a credit server 120 associated with a credit provider. In some embodiments, the computer system 100 can directly transmit the secondary transaction profile to the credit server 120. Alternatively, the computer system 100 can transmit the secondary transaction profile to a payment gateway 110, which in turn can transmit the secondary transaction profile to the credit server 120 on its own behalf. In still other embodiments, the computer system 100 can be integrated with or a component part of the payment gateway 110 and configured as a transaction data module operating therein.

In other variations of the embodiments, the computer system 100 can receive a confirmation from the credit server 120 of the secondary transaction profile associated with the credit transaction. As noted above, a secondary risk profile can be computed in response to the secondary transaction profile, by one or more of the computer system 100, the payment gateway 110, or the credit server 120. Accordingly, in response to calculation and/or receipt of the secondary risk profile, the computer system 100 can receive from the credit server 120 a discounted interchange rate for the associated credit transaction. Alternatively, the credit server 120 can directly transmit the discounted interchange rate to the payment gateway 110, which as noted above can be integral with or embodied with the computer system 100.

### 4. Method

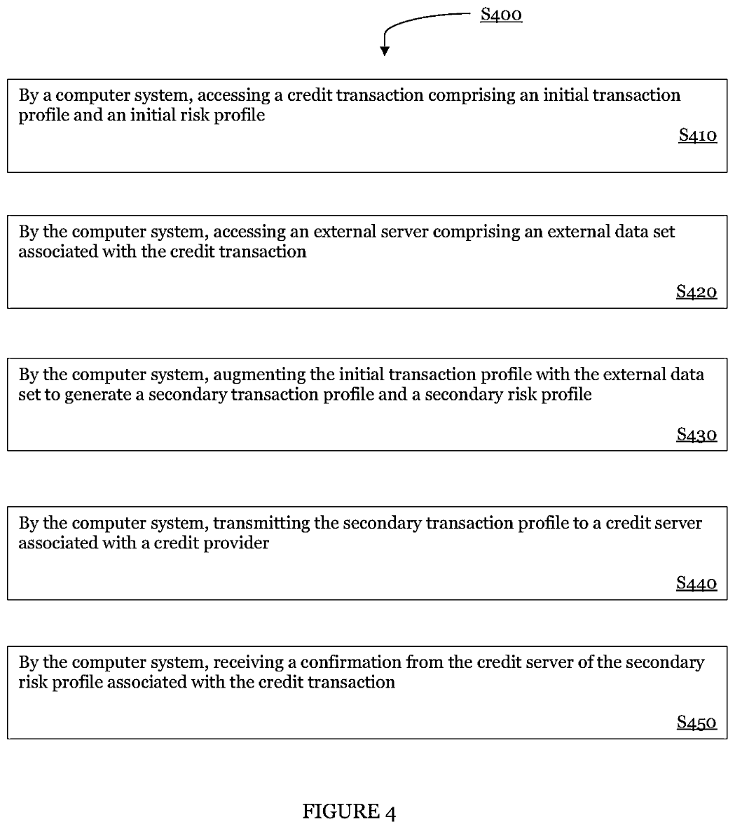

In some variations of the embodiments, the computer system 100 can be configured to implement or execute one or more techniques or methods. As shown in FIG. 4, a method S400 for augmenting or provisioning financial transaction data can include: accessing a credit transaction comprising an initial transaction profile and an initial risk profile in block S410; accessing an external server comprising an external data set associated with the credit transaction in block S420; and augmenting the initial transaction profile with the external data set to generate a secondary transaction profile and a secondary risk profile in block S430. As shown in FIG. 4, the method S400 can also include: transmitting the secondary transaction profile to a credit server associated with a credit provider in block S440; and receiving a confirmation from the credit server of the secondary transaction profile associated with the credit transaction in block S450.

As noted above, the credit transaction can include or be characterized by a set of underlying data from which an initial transaction profile and an initial risk profile is derived. In some embodiments, the initial transaction profile includes a set of data relating to the transaction, including information pertaining to the merchant, the purchaser, and/or the good/service being sold. In some embodiments, the initial risk profile is then generated in response to or as a function of the initial transaction data, and a borrowing rate is assigned to the transaction based at least in part upon the initial risk profile.

In variations of the embodiments, an external data set can include data and/or information relating to the merchant, the purchaser, the product, the location and/or jurisdiction of the purchase/sale, the means or method of delivery or shipment, etcetera. In some embodiments, the computer system can execute block S420 of the method S400 by accessing one or more external servers, at least one of which includes publicly available data (e.g., sales tax rates at the point of purchase/sale). In other embodiments, the computer system can execute block S420 of the method S400 by accessing the one or more external servers to retrieve, pull, scrape, and/or copy data or information that supports level three transactional data for the credit transaction.

As shown in FIG. 4, in some embodiments the computer system can execute block S430 of the method S400 to augment the initial transaction profile with the external data set to generate a secondary transaction profile and a secondary risk profile. As noted above, the initial transaction profile and the initial risk profile can be used by a credit issuing entity to set a rate of borrowing that is proportional to a level of risk associated with the transaction. Accordingly, the computer system can access the external data sets in block S420, augment or supplement the initial transaction profile with the externally-obtained information or data in block S430, and then generate a secondary transaction profile that includes a more complete (e.g., level three transaction data) assessment of the risk associated with the transaction.

In variations of the embodiments, the computer system executes block S430 of the method S400 to augment the initial transaction profile by completing a set of informational or data fields that provide a full set of level three transaction data. As noted above, the computer system can import a data element from the external data set (e.g., a middle initial of the purchaser, a purchaser zip code, a merchant zip code, shipping origin and destinations, etc.). Additionally or alternatively, the computer system can execute block S430 of the method by formatting, transforming, translating, and/or normalizing the data element the element into a compatible format suitable for reporting level three transaction data. In another embodiment, the computer system can execute block S430 of the method S400 by automatically entering the formatted element into one of the initial purchaser dataset or the initial merchant dataset as noted above.

In other variations of the embodiments, the computer system can execute block S440 of the method S400 by transmitting the secondary transaction profile to a credit server associated with a credit provider. In some variations of the embodiments, the computer system can directly transmit the secondary transaction profile to the credit server. Alternatively, the computer system can transmit the secondary transaction profile to a payment gateway, which in turn can transmit the secondary transaction profile to the credit server on its own behalf. In still other embodiments, the computer system can be integrated with or a component part of the payment gateway and configured as a transaction data module operating therein.

As shown in FIG. 4, in other variations of the embodiments, the computer system execute block S450 of the method S400 by receiving a confirmation from the credit server of the secondary transaction profile associated with the credit transaction. As noted above, a secondary risk profile can be computed in response to the secondary transaction profile, by one or more of the computer system, the payment gateway, or the credit server. Accordingly, in another variation of the embodiments, in response to calculation and/or receipt of the secondary risk profile, the computer system can receive from the credit server a discounted interchange rate for the associated credit transaction. Alternatively, the credit server can directly transmit the discounted interchange rate to the payment gateway, which as noted above can be integral with or embodied with the computer system.

Generally, the computer system can execute blocks of the method S400 in an operating environment of the type described above. For example, in executing blocks of the method S400, the computer system can communicate with a payment gateway, a credit server associated with a credit transaction (e.g., a credit card transaction), and one or more external databases including for example a public database, a merchant database, and a purchaser database. As described in detail below, in some embodiments two or more of the external databases can be assembled, combined, and/or managed as a single database and integrated with the computer system.

In variations of the embodiments, the computer system can execute blocks of the method S400 via one or more APIs that permit the computer system to: submit a request for data from the associated platform; receive or pull data from the associated platform; respond to a request for data from the associated platform; and transmit or push data to the associated platform. In some embodiments, the computer system and associated platforms can execute REST APIs. In other embodiments, the computer system and/or associated platforms can execute SOAP APIs. In still other embodiments, the computer system and associated platforms can execute APIs of other types or formats.

Other examples provide data enrichment for level three (3) compliance. In general, while managing data transactions, missing data or improperly formatted data may result in a transaction not qualifying as level ‘3’. Example embodiments provide a system, device and/or method for real-time data enrichment with financial transactions. The system may include a normalization engine 516, a database 530, and an enrichment engine 520 with a blank field population algorithm. The normalization engine 516 converts financial data from a variety of formats into a normalized format. The enrichment engine 520 enriches the normalized data with data from the database 530 using a blank field population algorithm and external sources.

The enrichment engine 520 may include a parser 512, a validator 514, a normalizer 516, and an enricher 518. In operation, the parser 512 parses the data from internal and external sources using a blank field population algorithm. The validator 514 validates the parsed data. The normalization engine 516 normalizes the validated data. The enricher 518 enriches the normalized data with the normalized financial data.

Normalizing data via the normalization engine 516 may include a process of transforming data into a consistent format so the data can be easily compared and analyzed. Normalization can involve converting data to a common unit of measurement, scaling data to a common range, and/or removing duplicate data. Normalizing data may enable easier data comparison of data received from different sources. For example, if data related to sales figures is received from different countries, the normalization of all such data to a common currency will optimize a data comparison process. Normalizing data permits seamless data analyzation. One example may include data regarding student test scores being normalized to a common scale so that the data can be compared to identify the performance of students from different classes or schools. In another example, data related to customer addresses can be normalized to a common format so that data can be merged from different sources or exported to other systems.

There are a different ways to normalize data, one normalization technique may include converting data to a common unit of measurement, such as when there are sales figures data in both dollars and euros. In this example, converting all of the data values to dollars prior to performing any comparison operations or merging operations may be a type of normalization. Another approach is to scale data to a common range, such as by converting all data values to a common range, such as 0 to 1 or −1 to 1. This can be useful for machine learning algorithms, which often require data to be in a specific range. Removing duplicate data may also be optimal to identify and remove duplicate data records to increase the accuracy and consistency of data.

Financial data can be normalized by converting all data values to a common currency and by scaling the data to a common range. This may enable the comparison of financial data from different sources and to analyze financial trends. Customer data can be normalized by removing duplicate customer records and by converting all customer data to a common format to improve the accuracy and consistency of customer data and make it easier to merge data from different sources or export data to other systems.

The database 530 stores the normalized financial data. The database 530 may be a relational database, a NoSQL database, or a cloud-based database. The synchronization engine 852 synchronizes the normalized financial data across platforms. Relational databases can be used to store data in tables that are related to each other through common keys or indexes. Examples of relational databases include proprietary platforms, such as MySQL, Oracle, and Microsoft SQL Server. Non-relational databases, such as NoSQL databases are a newer type of database that are designed to handle large amounts of data and unstructured data. NoSQL databases come in a variety of different types, including document databases, key-value stores, column-oriented databases, and graph databases. Examples of NoSQL databases include proprietary platforms, such as MongoDB, Cassandra, and HBase.

The synchronization engine 852 may use a variety of protocols to synchronize the data, such as FTP, SFTP, or HTTPS. The example process may provide optimized accuracy and consistency of financial data, reduced errors and inconsistencies in financial data, improved ability to track financial performance, and improved ability to make informed decisions regarding financial data.

The decimal place normalization 828 may occur in data tables with numerical data types. The process of ensuring that there are two decimal points and/or normalizing the data to two decimal points ‘$D, DDD.CC’ may be one approach to decimal place normalization since some systems do not have a form field requirement of decimal points when processing an amount that is equal to a whole number. Data type normalization 824 may normalize subtypes of numerical data. In one example, a data table using numerical data may be setup as a currency, an accounting number, text, general data, a number, and sometimes as a comma-style type of data. The varying subtypes of numerical data may cause certain applications to respond differently to applied formulas and various analytical treatments. One approach is to identify all types of varying data or accommodate types of data, and normalize those data types to the same data type. In one example, a default data style may be comma-style as it can be easily identified, labeled as a currency or accounting number if a presentation is performed. Also, a comma-style data format tends to undergo fewer updates over time during modifications, and thus a spreadsheet file may remain relevant across varying programs over usage and time.

The formatting normalization process 826 may be more common data strings (e.g., text, not numbers), however, it may be used with numbers as well. In most cases of formatting inconsistencies, one potential issue is with data italics since such formats may be distracting and can prevent inconsistencies, such as decimal places and data types from being identified. The Z-score normalization process may assist with datasets that include numerical values in multiple dimensions with significant differences in size. In one example, if there are values ranging from 10 to 100 in one dimension and values ranging from 100 to 100,000 in another, then it may be burdensome to compare the relative changes between those two separate values. The most common type of normalization process used for data modification may be the z-score normalization. A z-score process normalizes each data point to a particular standard deviation using the following formula:

$${x}^{′} = \frac{X - μ}{σ} \qquad Equation ( 1 )$$

where x′ is the data value, μ is the mean of the dataset, and σ is the standard deviation.

Linear normalization 834 is a simple and flexible normalization technique, which may include establishing a new “base” reference for each data point. Often called “max-min” normalization, this process permits taking the difference of the maximum ‘x’ value and minimum ‘x’ value in the set, and establishing a base. Data points can be normalized to any base once they have completed a linear normalization. The following equation may be used:

$${x}^{′} = \frac{x - min ( x )}{max ( x ) - min ( x )} \qquad Equation ( 2 )$$

In this example, if a base of 100 is desired and there is an “x” value of 20, the max number is 55 and the min number is 5. To normalize this number, the base of 50 is calculated as 55-5. Now the numerator needs to be modified with the same approach, i.e., x-min(x). In this case, it becomes 15 (or 20-5). In short, the standardized x, or x′, is 15/50=0.3.

Now, to normalize to 100, it may be necessary to multiply or divide the fraction by the number needed to get the denominator to 100. In this example, let's multiply by 2. For instance, 50 is multiplied by 2 to get 100 and 15 is multiplied by 2 to get 30. The standardization is 30/100 or 0.3. This is done to all numbers in the data set to get a 100 base standardization.

Another type of normalization (not shown in figures) is clipping. Although clipping may not be a normalization technique, it may be considered a tool analysts use before or after using normalization techniques. In short, clipping may include establishing maximum and minimum values for the dataset and requalifying outliers to this new max or min value. If there is a dataset of numbers [14, 12, 19, 11, 15, 17, 18, 95], the number 95 is a large outlier compared to the others. It can be clipped out of the data by reassigning a new high. Since the range without 95 is 11-19, you could reassign the max value at 19. It's important to note that clipping does not remove points from a data set, but merely reassigns data in a dataset. A quick check to ensure it is performed correctly is to make sure the data population N is the same before and after clipping, but that no outliers exist.

In the example of standard deviation normalization 836, assume that there are five rows with the IDs A, B, C, D, and E, each row containing ‘n’ different variables (columns). In this example, row E can be used. The remaining rows are normalized in the same way. The normalized value of e; for row E in the i^{th} column is calculated as:

$$Normalized ( {e}_{i} ) = \frac{{e}_{i}}{std ( E )} \qquad Equation ( 3 )$$

where

$$std ( E ) = \sqrt{\frac{1}{( n - 1 )}} {\sum }_{i = 1}^{n} {( {e}_{i} - \overline{E} )}^{2} \qquad Equation ( 4 )$$

and

$$\overline{E} = \frac{1}{n} {Σ}_{i = 1}^{n} {e}_{i} . \qquad Equation ( 5 )$$

If all values for row E are identical, the standard deviation of E (std(E)) is equal to zero and all values for row E are set to zero.

The result of one or more of the normalization examples is an output of database 530. The database is the source of information for data collected from all external sources. Output to external systems may require automatic reformatting of data to fit within form fields on external systems. In some cases, the data may be clipped or deviate from the standardized data format in such a way that restricting the normalization standards to that level would sacrifice data integrity across all platforms. In this case, output data that is manipulated is saved in a standardized format.

In operation, the data received 810 may be inputted manually 812 for staging 816, parsing 818 and validation 822 prior to the one or more normalization processes. Data may be presented to a user interface via an API 814, which is managed by a synchronization engine 852. The output of the database 530 may include data that is prepared 840 for insertion in one or more output interfaces used by a consumer software application. The data may be prepared for a form field validation and normalization process 842 and may be converted 844 based on the available formats stored in the database 530. The data may be presented 846 in a visual format and queried by any one or more of the known data management applications (e.g., ORACLE, NETSUITE, QUICKBOOKS, SALESFORCE, etc.). The result of a query 848 initiated to identify a specific data realization may be visualized 850 in an application interface.

A real-time data enrichment process may utilize financial transactions and reduce interchange fees and credit card/financial fraud. By enriching the normalized financial data with data from internal and external sources, the system can make more informed decisions about whether to approve or decline a transaction, which can provide optimal results and reduce loss. Example embodiments provide a data management process can reduce a number of fraudulent transactions, which can save financial institutions money on interchange fees. The data management process may provide real-time data enrichment, a normalized data standard, a blank field population algorithm, improved accuracy of risk assessments, reduced interchange rates. The present application provides a system and process to enrich data in a credit card transaction in real-time, using a normalized data standard and a blank field population algorithm. The enriched data is then used by card brands to evaluate risk on a per transaction basis, resulting in improved accuracy of risk assessments and reduced interchange rates.

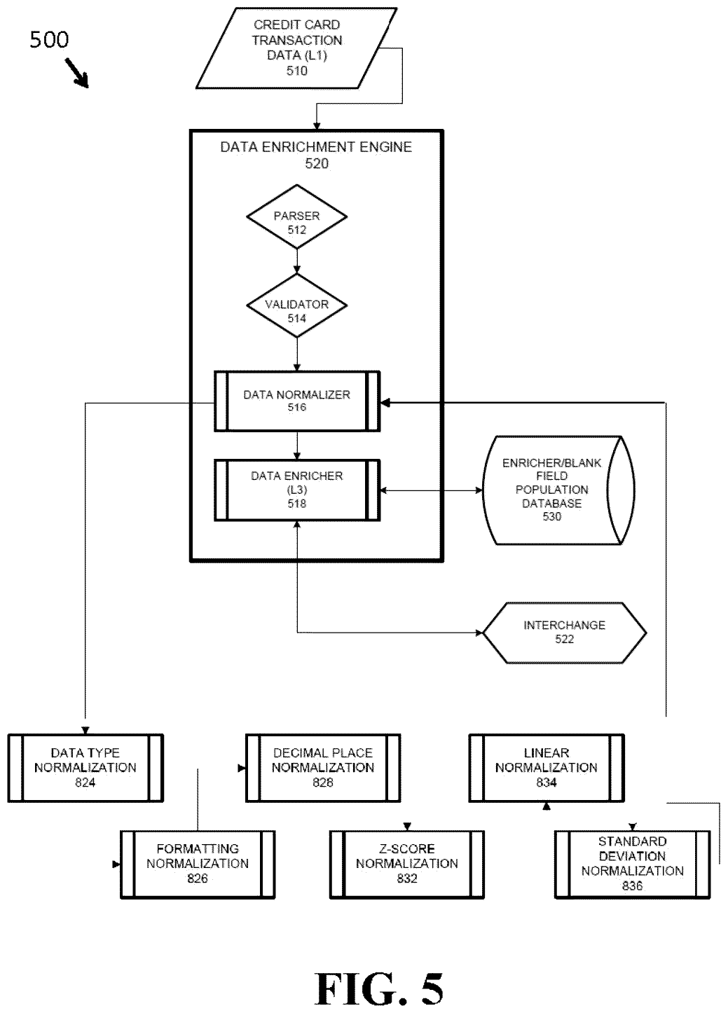

FIG. 5 is a block diagram of a data enrichment process according to example embodiments of the present invention. Referring to FIG. 5, the credit card transaction data for the level 1 data (L1) 510 is received via the data enrichment engine 520 which includes a parser 512 for parsing the L1 data from internal and external data sources using a blank field population algorithm. The validator 514 validates the parsed data based on validation criteria and provides the data to a data normalizer 516, which normalizes the data in a financial data format that can be enriched via data enricher 518, which processes the level 3 data (L3). The blank field data population process may be used by referencing the database 530. The internal and external data sources can be used to provide an approval or denial of the transaction data that is sent to one or more financial processing interchanges 522. The risk of fraudulent transactions can reduce the need to charge interchange fees when assessing a risk of the transaction.

The database 530 stores the normalized data. The synchronization engine 852 synchronizes the normalized data across those varying different platforms. The normalization engine 516 may also include a parser 512, and a validator 514 as well as a normalizer. In some embodiments, normalizer may include various normalization processes 824-836. Parser 512 parses the financial data from a variety of formats, and validator 514 validates the parsed financial data. The normalizer normalizes the validated financial data. Any of the example normalization processes may also be referred to as procedures which occur as part of a process that includes the one or more normalization procedures.

When validating parsed data, a check may be made to ensure that the data meets certain criteria. The criteria can vary depending on the specific data type and the intended use of the data. In one example, validation of a data field to may be performed to determine whether the data is in a valid format and within a certain range of dates. Other examples may include an email address field being validated to verify a valid data format. A number field may also be validated to ensure that it is within a certain range of numbers. Validating parsed data may prevent errors and inconsistencies in the data especially financial data, where even small errors can have a significant impact.

Parsed data can be validated may performing one or more of checking that a string field is not empty, checking that an email address field is in a valid format, checking that a date field is in a valid format and that it is within a certain range of dates, checking that a number field is within a certain range of numbers, checking that a list of items contains at least one item, checking to make sure that a JSON object contains all of the required fields, etc.

Validating parsed data can be performed using a variety of different approaches. One approach is to use a validation library. Validation libraries provide a set of pre-built validation functions that can be used to validate different types of data, or another approach is a custom written validation code.

### 5. Example Implementations

As described above, the computer system 100 can execute blocks of the method S400 to automatically access, translate, transform, and update transactional data (e.g., to include level three transactional data) to a credit server 120 such that a user associated with a payment gateway 110 can benefit from discounted interchange rates in financing credit-based transactions.

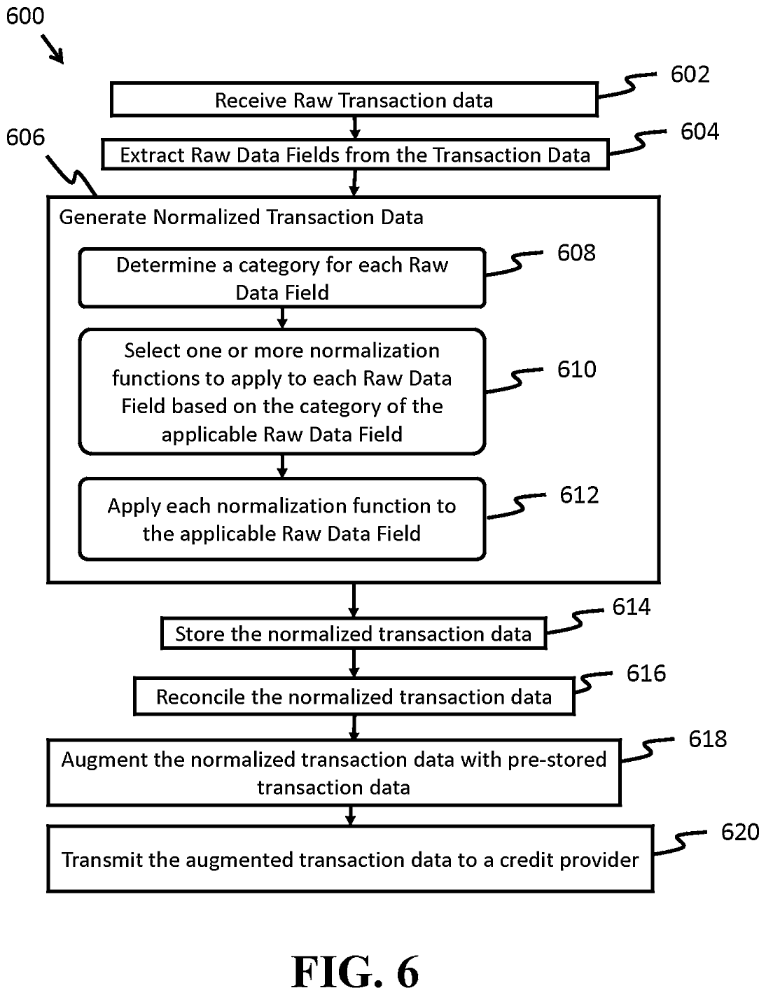

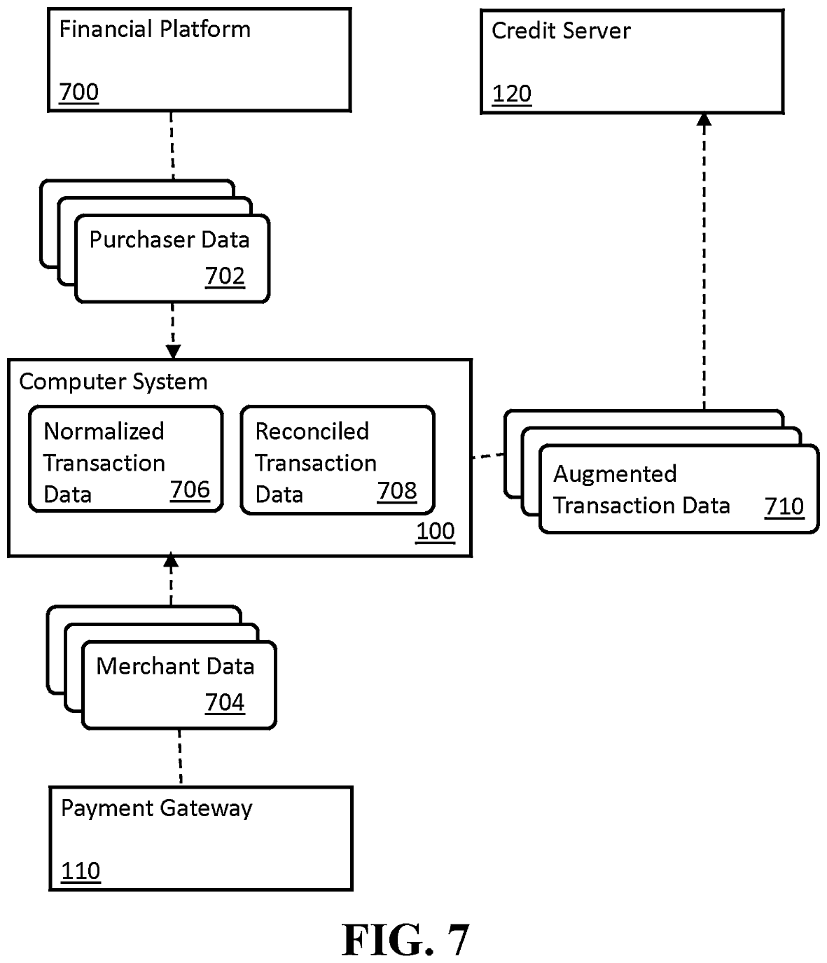

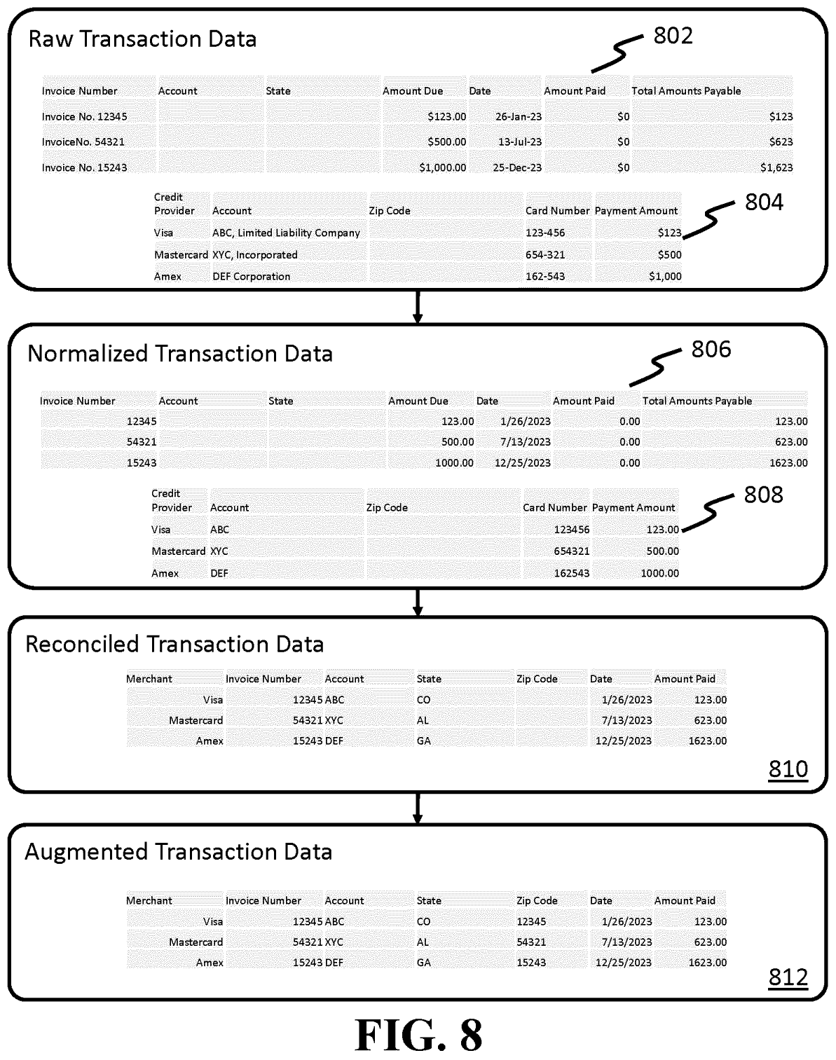

Referring now to FIGS. 6 and 7, the method for augmenting or provisioning financial transaction data introduced above via the method S400 is discussed in greater detail, according to some embodiments of the present disclosure. Such a method 600 may include a first step 602, where the computer system 100 receives transaction data (e.g., the transaction data 510) from the payment gateway 110. As discussed above, the transaction data 510 may be level 1 data. In this sense, the transaction data 510 may include basic (e.g., “raw”) transaction data, including raw merchant data (e.g., raw merchant data 802 depicted with reference to FIG. 8, invoice data, data regarding the merchant associated with the payment gateway 110, etc.), raw purchaser data (e.g., raw purchaser data 804 depicted with reference to FIG. 8, data regarding the purchaser, which may be associated with at least a portion of the purchaser data 150, etc.), and raw credit provider data (e.g., regarding the credit provider associated with the credit server 120). In some cases, the payment gateway 110 already has the raw purchaser data on-hand, as suggested above. In other cases, a financial platform 700 associated with the purchaser (e.g., a mobile wallet, an accounting platform, etc.), provides the raw purchaser data in the form of purchaser data 702. Similarly, in some cases, the payment gateway 110 already has the raw credit provider data on-hand (as previously provided by the credit server 120, for instance). In other cases, the financial platform 700 provides the raw credit provider data in the form of the purchaser data 702. In this sense, the payment gateway 110 may simply provide a merchant invoice, and corresponding payment information for filling the invoice is provided from external sources such as the financial platform 700.

Accordingly, based on the receipt of the transaction data 510 from the payment gateway 110 and, in some cases, the purchaser data 702 from the financial platform 700, the computer system 100 may then be in possession of “raw transaction data”, which may include raw merchant data, raw purchaser data, and raw credit provider data which, if compiled and submitted to the credit server 120 (as may be the case in conventional systems), would amount to the submission of level 1 transaction data to the credit server 120, which may result in the various associated disadvantages discussed herein. Thus, the “raw transaction data” may be considered as a number of sets of such raw transaction data (e.g., a set of raw transaction data relating to the raw merchant data, a set of raw transaction data relating to the raw purchaser data, and a set of raw transaction data relating to the raw credit provider data).

As shown with particular reference to FIG. 8, the number of sets of raw transaction data making up the raw transaction data may include a set of raw merchant data 802 received from a first financial platform 500, and a set of raw purchaser data 804 received from a second financial platform 502. As suggested above, the raw transaction data may further include raw credit provider data. While such raw credit provider data may be considered a third set of raw transaction data, in the exemplary body shown, such raw merchant data is included among the raw purchaser data 804 (e.g., the “Credit Provider” data field, for example). For each of the first and second sets of transactional data 802, 804, the raw transaction data may include a number of raw data fields associated with a number of categories of transaction data. As an example, the set of raw merchant data 802 may be considered invoice data, and therefore include categories of transaction data such as an invoice number, an amount due, a date, an amount paid, and a running total amounts payable category. For the exemplary purposes herein, it may be assumed that the set of raw merchant data 802 may not include relevant data such as an “account” data or “state” data. Similarly, the set of raw purchaser data 804 may be payment data, and therefore include categories of financial data such as a credit provider, an account, a card number, and a payment amount for processing. For the exemplary purposes herein, it may be assumed that the set of raw purchaser data 804 may not include relevant data such as “zip code.”

The method 600 may then proceed with a step 604, where the computer system 100 extracts, from the number of sets of raw transaction data, a number of raw data fields. Such a process may be performed by the parser 512 depicted with reference to FIG. 5. Accordingly, computer system 100 provided for herein may be configured to extract, from a number of sets of transaction data (e.g., the raw merchant data 804, the raw purchaser data 802, etc.), a number of raw data fields associated with a number of categories of transaction data, wherein the number of sets of transaction data includes at least a first set of transaction data received from a financial platform (e.g., the raw purchaser data 804) and a second set of transaction data associated with at least one credit provider (e.g., the raw merchant data 804), where the second set of transaction data includes an identification associated with each of the at least one credit provider (e.g., “Visa,” “Mastercard,” “Amex” among the raw merchant data 804);

The method 606 may proceed with a step 606, where the computer system 100 generates normalized transaction data. Such a process may be performed by the validator 514 depicted with reference to FIG. 5. For instance, with respect to each “raw data field,” the computer system 100 may, in a step 608 of the method 600, determine a category of the raw data field. Referring again to the “invoice number” raw data field of the raw purchaser data 802 depicted in FIG. 8, the computer system 100 may reference the title “invoice number,” as well as the values thereunder (“Invoice No. 123456,” “Invoice No. 54321,” etc.) and determine within a confidence threshold, that the raw data field is of the category “invoice number.” In turn, with respect to each raw data field, the computer system 100 (e.g., the validator 514) may, in a step 610 of the method 600, select one or more normalization functions to apply to each raw data field based on the category. For example, each of the normalization functions 824, 826, 828, 832, 834, and 836 may be pre-determined and stored in the database 530, and may be selected based on the determination made in step 610.

In some embodiments, in the step 610, the one or more normalization functions are selected based on an identification of the credit provider. For instance, each different credit provider (e.g., the exemplary identifications of “Visa,” “Mastercard,” and “Amex” as listed in the raw purchase data 804) may have a distinct configuration of formatting that is associated with level three transaction data. String data such as “Visa” may be read and understood, by the computer system 100, as indicating within a confidence threshold that Visa is in fact the credit provider. Of course, in other embodiments of the present disclosure, such identifications of the credit provider are provided in other formats, such as unique identification numbers, and may be provided from other sources of transaction data (e.g. among the raw merchant data 802, provided independently from the credit server 120, and so on). Moreover, an identification of the credit provider may be entirely missing from the raw transactional data. As discussed in greater detail below, the identification of the credit provider may be determined and augmented onto the transaction data.

The method 600 may then proceed with a step 612, where the computer system 100 applies each of the normalization functions selected in step 610 to the raw data field. For example, referring again to the “invoice number” raw data field of the raw purchaser data 802 depicted in FIG. 8, the normalization functions may be applied such that the “invoice number” data field may be normalized to remove the leading “invoice no.” text, leaving the trailing numeric values in the data field as shown in the corresponding normalized set of purchaser data 806. This normalized data field may thus be standardized with respect to any other record containing invoice numbers in the database 530. As discussed below, each such normalization function applied to each “raw” data field may be recorded by the computer system 100 in the database 530, for the purposes of ultimately transmitting the data back to a requesting financial platform.

Of course, the steps 608, 610, and 612 as discussed above may be repeated for each “raw” data field of each set of financial data (e.g., raw purchaser data 802 and the raw merchant data 804). Thus, the same steps may be applied to each of the remaining data fields depicted in the raw purchaser data 802 in FIG. 8, as well as each data field depicted in the raw merchant data 804 depicted in FIG. 8. Thus, normalized data may be generated for all transaction data received by the computer system 100, thus generating normalized transactional data as depicted with reference to FIG. 8 (and, more specifically, normalized purchaser data 806 and normalized merchant data 808 depicted with reference to FIG. 8).

Accordingly, the computer system 100 provided for herein may be configured to generate a set of normalized transaction data (e.g., the normalized purchaser data 806 and the normalized merchant data 808), the set of normalized transaction data including a number of sets of normalized data having a number of normalized data fields each corresponding to a raw data field of the number of raw data fields, where generating each of the plurality of normalized data field includes: (1) determining, for a raw data field, a category of the plurality of categories of transaction data, (2) based on the category, selecting a first one or more normalization functions from a plurality of normalization functions stored in the database, and (3) applying each of the first one or more normalization functions to the raw data field in order to generate a normalized data field of the number of normalized data fields. Such normalized data may be stored in the database 530.

The method 600 may proceed with a step 614, where the computer system 100 stores the normalized transaction data 706 in the database 530. The method 600 may then proceed with a step 616 where the computer system 100 generates reconciled transaction data 708. Such a step may be completed by the data normalizer 516 depicted with reference to FIG. 5. In particular, the computer system 100 may reconcile the normalized merchant data 806 with the normalized purchaser data 808. The computer system 100 may conduct this step 616 successfully due to the fact that such transaction data has been normalized, and thus corresponds to one another in terms of the values of the data fields. For instance, as shown with reference to FIG. 8, the normalized merchant data 806, which may be invoice data, is shown to be reconciled with the normalized purchaser data 808, which may be payment data, thereby producing reconciled transaction data 708 in a state that may be transmitted to the credit provider 120 for payment processing. The “amount paid” and “amount due” data fields of the normalized merchant data 806 has been shown to have accounted for the “payment amount” data field of the normalized purchaser data 808, and thus the reconciled transaction data 708 is shown to reflect the appropriate “amount paid” data field (e.g., “123.00,” “623.00,” and “1623.00”).

In some embodiments, the reconciling of the transaction data of the step 616 includes identification of a blank data field among one set of normalized transaction data, identification of a filled data field among the other set of normalized transaction data, where the filled data filed corresponds to the blank data field, and appending the filled data field to the reconciled transaction data. As an example, the “account” data field of the raw merchant data 802 and, thus, the “account” data field of the normalized merchant data 806, is shown to be blank. On the other hand, the “account” data field of the raw purchaser data 802 and, thus, the “account” data field of the normalized purchaser data 808, is filled. In turn, this filled data may be accordingly appended to the reconciled transaction data 810, as shown. This process may be considered distinct from the general process of reconciling the transaction data, in that the general process evaluates filled data fields on one set of transaction data to filled data fields on the other set of transaction data, in order to arrive at reconciled data that reflects the appropriate data for processing of the transaction. Such appending of transaction data to the reconciled transaction data 810 may be similar to the process of augmenting the reconciled transaction data with external data discussed in greater detail below, in that the processes advantageously maximize the amount of fields of accurate, properly formatted data that is transmitted to the credit provider 120 in order to ensure that the transaction data is processed as level three transaction data, thereby affording the corresponding advantages discussed herein.

Accordingly, the computer system 100 may be configured to generate reconciled transaction data (e.g., the reconciled transaction data 810) by reconciling the first number of sets of normalized transaction data (e.g., the normalized purchaser data 806 and the normalized merchant data 808), the reconciled transaction data having a number of reconciled data fields each corresponding to a normalized data field of the number of normalized data fields.

It should be appreciated that the reconciled transaction data 810 may be appropriate for transmitting to the credit provider 120 for successful processing of the purchaser's payment. However, the “zip code” data field of the reconciled transaction data 810 is shown to be blank. For instance, the “zip code” data field of the raw purchaser data 804 was blank, and there was no “zip code” data field of the raw merchant data 802 to be appended to the reconciled transaction data 810. Such is an example of missing data fields which may typically result in the credit provider 120 processing the transaction as level one data, thus relating to the disadvantages discussed herein.

In this sense, the reconciled transaction data 810 may represent an initial transaction profile with a first corresponding risk profile (as determined by the credit provider 120). Based on the steps below and the steps to follow, the computer system 100 may be prompted (e.g., by a request from the financial platform 700), to transmit transaction data related to a particular transaction to a particular credit provider, with the objective of transmitting what would otherwise be level one data (based on the first corresponding risk profile) in a format that may be operable under the credit provider 120 as level three data. For instance, as shown in FIG. 8, the transaction data corresponds to multiple credit providers. The computer system 100 may be prompted to transmit the transaction data associated with the transaction with “Visa” to the credit provider 120, where the credit provider 120 is associated with “Visa.” The data regarding “Visa,” “Mastercard,” and “Amex” may each serve as identifications of various credit providers, which may be parsed by the computer system 100 in order to select the applicable transaction data based on a particular prompt.

As suggested above, it would be advantageous to ensure that the aforementioned “zip code” data field of the reconciled transaction data 810 is filled with accurate, properly formatted data, thereby ensuring that the transaction data is processed as level three transaction data. Accordingly, the method 600 may proceed with a step 618, where the computer system 100 augments the normalized transaction data with pre-stored transaction data, as discussed above with reference to step S430 above with reference to FIG. 4. For example, the computer system 100 may extract an identification of the purchaser from the raw purchaser data 804, and reference data regarding the purchase in the database 530. In some embodiments, the database 530 includes, or is in communication with, an external server hosting publicly available data (e.g., sales tax rates at the point of purchase/sale, shipment location data, etc.).

In some cases, the determination is not able to be made from the raw purchaser data 804 (e.g., the computer system 100 does not recognize a purchase under the name “ABC, Limited Liability Company”). In such cases, the determination is instead able to made form the normalized purchaser data 808 (e.g., the computer system 100 does in fact recognize the purchaser “ABC” in the database 530). In either case, the computer system 100 may, based on the identification of the purchaser, extract the missing data from the database 530, and augment the extracted data onto the reconciled transaction data 810, thereby arriving at the augmented transaction data 812. For example, the computer system 100 may, in the database 530, have a pre-stored zip code associated with the user “ABC,” which may in turn be extracted and augmented to the transaction data. In this exemplary scenario shown, the addition of the “zip code” data may advantageously convert the transaction data from level one data, from the perspective of the credit provider, to level three data.

In some embodiments, the determination to augment certain data onto the transaction data is based on an identification of the particular credit provider processing the transaction. For instance, returning to the example involving the user “ABC” and the augmentation of the “zip code” data, the computer system 100 may determine an identity of the applicable credit provider for processing the transaction. Such an identification may be made based on the raw and/or normalized transaction data. For example, the computer system 100 may identify “Visa” from the “credit provider” data on the normalized merchant data 808 (or, as suggested herein, the computer system 100 may receive an appropriate indication directly from the credit provider). In turn, the computer system 100 may reference the identification of “Visa” with a corresponding profile of level three data that is pre-stored in the database 530. Such a profile may include a list of data fields that need to be included in order to be processed as level three data by the applicable credit provider (in this case, “zip code” data is required by “visa”). In some embodiments, the profile may also include appropriate identification of formatting that the data fields must be provided in, in order for the credit provider to process the data as level three data. In this sense, in some embodiments, a process similar to the step 606 (normalization of the transaction data) may be repeated as necessary to augment the data in the appropriate format for processing, by the credit provider, as level three data.

Accordingly, the computer system 100 provided for herein may be configured to generate a set of augmented transaction data (e.g., the augmented transaction data 812), where generating the set of augmented transaction data includes:
(1) selecting reconciled transaction data that is associated with an identification of the first credit provider of the one or more identifications (e.g., where “Visa” is the applicable credit provider for transmitting the transaction data, the information associated with “Visa” among the reconciled transaction data 81), (2) selecting, based on the identification of the first credit provider, one or more pre-stored data fields from the database (e.g., the pre-stored data from the database 530, along with data from external servers using publicly available sources), and (3) augmenting the one or more pre-stored data fields onto the selected reconciled transaction data (e.g., shown with respect to “Visa” on the augmented transaction data 812).

In some embodiments, the normalization conducted at the step 606 is based on a first configured process of normalization (e.g., the combinations of normalization functions applied to the data fields), and the normalization conducted at the present step 618 is based on a second configured process of normalization. In this sense, the computer system 100 may conduct the step 606 with a first normalization process that is specific to the computer system 100 conducting optimized reconciling of the transaction data, and the computer system 100 may conduct the step 618 with a second normalization process that is specific to the identified format of transaction data associated with the applicable credit provider, for the specific purpose of providing the credit provider with level three transaction data. Advantageously, bifurcation of the normalization process in such a manner may better achieve accurate processing of data (in one independent normalization process) and proper formatting for providing the transaction data for processing by the credit provider as level three transaction data (through a second independent normalization process).

Accordingly, the computer system 100 as provided herein may be further configured to normalize the selected reconciled transaction data (e.g., the “Visa” data of the reconciled transaction data 812), wherein normalizing the selected reconciled transaction data includes, for each reconciled data field of the selected transaction data: (1) determining, for the reconciled data field, a category of the number of categories of transaction data, (2) determining, for the reconciled data field, and based on the identification of the first credit provider, that the data is associated with the first credit provider (e.g., “Visa”) of the at least one credit provider, (3) based on the category and the identification of the first credit provider, selecting a second one or more normalization functions from the number of normalization functions stored in the database 530, and (4) applying each of the second one or more normalization functions to the reconciled data field.

Of course, it should be appreciated that there may be a multitude of additional data fields that the transaction data is augmented to include, and the embodiments discussed herein should be understood as exemplary in nature.

The method 600 may conclude with a step 620 where the computer system 100 transmits the augmented transaction data (e.g., the augmented transaction data 812 depicted with reference to FIG. 8) to the credit provider 120. In this sense, the augmented transaction data associated with “Visa” may be transmitted to the credit provider 120 associated with “Visa.”

It will be readily understood that the components of various embodiments of the present invention, as generally described and illustrated in the figures herein, can be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification can be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics can be combined in any suitable manner in one or more embodiments.

It should be noted that reference throughout this specification to features, advantages, or similar language does not imply that all of the features and advantages that can be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification can, but do not necessarily, refer to the same embodiment.

Furthermore, the described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention.

One having ordinary skill in the art will readily understand that the invention as discussed above can be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

In some embodiments, the present disclosure improves the functionality of a computing device. For example, in one embodiment, the systems and methods described herein may facilitate the enhanced facilitation of improved transaction data that asserts an improved risk profile, thereby gaining access to discounted transaction costs at the hands of a credit provider. Moreover, the systems and methods may improve the way a computing device, such as the computer system 100, stores, reconciles, and distributes transaction data pursuant to this objective. For example, by normalizing the received transaction data (e.g., the raw purchaser data 802 and the raw merchant data 804 depicted with reference to FIG. 8) received from various disconnected sources (e.g., the first financial platform 700 and the payment gateway 110, and reconciling such transaction data, the computer system 100 may be enabled to enhance the speed and accuracy of the reported transaction data provided to the credit provider 120, which may receive the transaction data in a format that achieves the advantageous level three profile. As discussed above, achieving a level three profile may require the augmentation of certain data, as well as normalizing the data to a provider-dependent format. Over repeated transactions, by storing information about the credit provider (e.g., its preferred formatting), the purchaser, and its associated transactions, the processing requirements for ensuring transactions may be reduced due to the pre-storage of normalized data configured during previous transactions.

As discussed herein, the present disclosure includes components that are not well-understood, routine, or conventional. For example, the determination of particular and bespoke combinations of normalization functions, which are converted to corresponding combinations of translation functions, is not conventional. This unconventional activity may result in more accurate transaction data reported by the computer system 100, saving transaction costs, provided at greater speeds, with reduced computational effort.

It will be readily understood that the components of various embodiments of the present invention, as generally described and illustrated in the figures herein, can be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification can be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics can be combined in any suitable manner in one or more embodiments.

It should be noted that reference throughout this specification to features, advantages, or similar language does not imply that all of the features and advantages that can be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification can, but do not necessarily, refer to the same embodiment.

Furthermore, the described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention.

One having ordinary skill in the art will readily understand that the invention as discussed above can be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

Thus, although there have been described particular embodiments of the present invention of a new and useful SYSTEM AND METHOD FOR THE AUTOMATED PROVISION OF TRANSACTIONAL DATA, it is not intended that such references to particular embodiments be construed as limitations upon the scope of this invention.

What is claimed is:

1. A data processing system for reconciling financial data, the system comprising a computing device including a processor, a database, and a memory, the memory storing instructions operative by the processor to:
extract, from a plurality of sets of transaction data, a plurality of raw data fields associated with a plurality of categories of transaction data, wherein the plurality of sets of transaction data includes at least a first set of transaction data received from a financial platform and a second set of transaction data associated with at least one credit provider, wherein the second set of transaction data includes an identification associated with each of the at least one credit provider;
generate a set of normalized transaction data, the set of normalized transaction data including a plurality of sets of normalized data having a plurality of normalized data fields each corresponding to a raw data field of the plurality of raw data fields, wherein generating each of the plurality of normalized data field includes:
determining, for a raw data field, a category of the plurality of categories of transaction data,
based on the category, selecting a first one or more normalization functions from a plurality of normalization functions stored in the database, and
applying each of the first one or more normalization functions to the raw data field in order to generate a normalized data field of the plurality of normalized data fields;
store the set of normalized transaction data in the database;
generate reconciled transaction data by reconciling the plurality of sets of normalized transaction data, the reconciled transaction data having a plurality of reconciled data fields each corresponding to a normalized data field of the plurality of normalized data fields;
store the reconciled transaction data in the database;
receive a request from the financial platform to transmit transaction data to a first credit provider of the at least one credit provider;
in response to the request, generate a set of augmented transaction data, wherein generating the set of augmented transaction data includes:
selecting reconciled transaction data that is associated with an identification of the first credit provider of the one or more identifications;
selecting, based on the identification of the first credit provider, one or more pre-stored data fields from the database, and
augmenting the one or more pre-stored data fields onto the selected reconciled transaction data; and
transmit the set of augmented transaction data to the credit provider.

2. The data processing system of claim 1, wherein the database includes an external server of publicly available data, and wherein at least a portion of the pre-stored data fields selected from the database is selected from the external server of publicly available data.

3. The data processing system of claim 2, wherein the plurality of sets of transaction data is associated with an initial risk profile with respect to each of the at least one credit provider, wherein the set of augmented transaction data is associated with a secondary risk profile, and wherein the secondary risk profile associated with the set of augmented transaction data is operable to be computed by the credit provider as level three transaction data.

4. The data processing system of claim 3, wherein the secondary risk profile associated with the set of augmented transaction data is operable to be computed by the credit provider under a discounted interchange rate.

5. The data processing system of claim 4, wherein the plurality of normalization functions includes:
a decimal place normalization function;
a data type normalization function;
a formatting normalization function;
a z-score normalization function;
a linear normalization function;
a clipping normalization function; and
a standard deviation normalization function.

6. The data processing system of claim 5, wherein the one or more credit providers includes a plurality of credit providers.

7. The data processing system of claim 6, wherein generating the set of augmented transaction data further includes
normalizing the selected reconciled transaction data, wherein normalizing the selected reconciled transaction data includes, for each reconciled data field of the selected transaction data:
determining, for the reconciled data field, a category of the plurality of categories of transaction data,
determining, for the reconciled data field, and based on the identification of the first credit provider, that the data is associated with the first credit provider of the at least one credit provider;
based on the category and the identification of the first credit provider, selecting a second one or more normalization functions from the plurality of normalization functions stored in the database, and
applying each of the second one or more normalization functions to the reconciled data field.

8. A data method for reconciling financial data, the method comprising:
extracting, from a plurality of sets of transaction data, a plurality of raw data fields associated with a plurality of categories of transaction data, wherein the plurality of sets of transaction data includes at least a first set of transaction data received from a financial platform and a second set of transaction data associated with at least one credit provider, wherein the second set of transaction data includes an identification associated with each of the at least one credit provider;
generating a set of normalized transaction data, the set of normalized transaction data including a plurality of sets of normalized data having a plurality of normalized data fields each corresponding to a raw data field of the plurality of raw data fields, wherein generating each of the plurality of normalized data field includes:
determining, for a raw data field, a category of the plurality of categories of transaction data,
based on the category, selecting a first one or more normalization functions from a plurality of normalization functions stored in the database, and
applying each of the first one or more normalization functions to the raw data field in order to generate a normalized data field of the plurality of normalized data fields;
storing the set of normalized transaction data in the database;
generating reconciled transaction data by reconciling the plurality of sets of normalized transaction data, the reconciled transaction data having a plurality of reconciled data fields each corresponding to a normalized data field of the plurality of normalized data fields;
storing the reconciled transaction data in the database;
receiving a request from the financial platform to transmit transaction data to a first credit provider of the at least one credit provider;
in response to the request, generating a set of augmented transaction data, wherein generating the set of augmented transaction data includes:
selecting reconciled transaction data that is associated with an identification of the first credit provider of the one or more identifications;
selecting, based on the identification of the first credit provider, one or more pre-stored data fields from the database, and
augmenting the one or more pre-stored data fields onto the selected reconciled transaction data; and
transmitting the set of augmented transaction data to the credit provider.

9. The method of claim 8, wherein the database includes an external server of publicly available data, and wherein at least a portion of the pre-stored data fields selected from the database is selected from the external server of publicly available data.

10. The method of claim 9, wherein the plurality of sets of transaction data is associated with an initial risk profile with respect to each of the at least one credit provider, and wherein the set of augmented transaction data is associated with a secondary risk profile.

11. The method of claim 10, wherein the secondary risk profile associated with the set of augmented transaction data is operable to be computed by the credit provider as level three transaction data.

12. The method of claim 11, wherein the secondary risk profile associated with the set of augmented transaction data is operable to be computed by the credit provider under a discounted interchange rate.

13. The method of claim 12, wherein the plurality of normalization functions includes:
a decimal place normalization function;
a data type normalization function;
a formatting normalization function;
a z-score normalization function;
a linear normalization function;
a clipping normalization function; and
a standard deviation normalization function.

14. The method of claim 13, wherein the one or more credit providers includes a plurality of credit providers.

15. The method of claim 14, wherein generating the set of augmented transaction data further includes
normalizing the selected reconciled transaction data, wherein normalizing the selected reconciled transaction data includes, for each reconciled data field of the selected transaction data:
determining, for the reconciled data field, a category of the plurality of categories of transaction data,
determining, for the reconciled data field, and based on the identification of the first credit provider, that the data is associated with the first credit provider of the at least one credit provider;
based on the category and the identification of the first credit provider, selecting a second one or more normalization functions from the plurality of normalization functions stored in the database, and
applying each of the second one or more normalization functions to the reconciled data field.

16. A non-transitory computer readable medium carrying computer executable instructions which, when executed by a processor, cause the processor to perform operations comprising:
extracting, from a plurality of sets of transaction data, a plurality of raw data fields associated with a plurality of categories of transaction data, wherein the plurality of sets of transaction data includes at least a first set of transaction data received from a financial platform and a second set of transaction data associated with at least one credit provider, wherein the second set of transaction data includes an identification associated with each of the at least one credit provider;
generating a set of normalized transaction data, the set of normalized transaction data including a plurality of sets of normalized data having a plurality of normalized data fields each corresponding to a raw data field of the plurality of raw data fields, wherein generating each of the plurality of normalized data field includes:
determining, for a raw data field, a category of the plurality of categories of transaction data,
based on the category, selecting a first one or more normalization functions from a plurality of normalization functions stored in the database, and
applying each of the first one or more normalization functions to the raw data field in order to generate a normalized data field of the plurality of normalized data fields;
storing the set of normalized transaction data in the database;
generating reconciled transaction data by reconciling the plurality of sets of normalized transaction data, the reconciled transaction data having a plurality of reconciled data fields each corresponding to a normalized data field of the plurality of normalized data fields;
storing the reconciled transaction data in the database;
receiving a request from the financial platform to transmit transaction data to a first credit provider of the at least one credit provider;
in response to the request, generating a set of augmented transaction data, wherein generating the set of augmented transaction data includes:
selecting reconciled transaction data that is associated with an identification of the first credit provider of the one or more identifications;
selecting, based on the identification of the first credit provider, one or more pre-stored data fields from the database, and
augmenting the one or more pre-stored data fields onto the selected reconciled transaction data; and
transmitting the set of augmented transaction data to the credit provider.

17. The non-transitory computer readable medium of claim 16, wherein the database includes an external server of publicly available data, and wherein at least a portion of the pre-stored data fields selected from the database is selected from the external server of publicly available data.

18. The non-transitory computer readable medium of claim 17, wherein the plurality of sets of transaction data is associated with an initial risk profile with respect to each of the at least one credit provider, and wherein the set of augmented transaction data is associated with a secondary risk profile.

19. The non-transitory computer readable medium of claim 18, wherein the secondary risk profile associated with the set of augmented transaction data is operable to be computed by the credit provider as level three transaction data under a discounted interchange rate.

20. The non-transitory computer readable medium of claim 19, wherein the plurality of normalization functions includes:
a decimal place normalization function;
a data type normalization function;
a formatting normalization function;
a z-score normalization function;
a linear normalization function;
a clipping normalization function; and
a standard deviation normalization function.
